(19) United States
(12) Patent Application Publication
(10) Pub. No.: US 2012/0076967 A1
(43) Pub. Date: Mar. 29, 2012

(54) Sheet Affixing Structure

(76) Inventor: Hiroaki Muramatsu, Yokohama (JP)

(21) Appl. No.: 13/073,042

(22) Filed: Mar. 28, 2011

(30) Foreign Application Priority Data
Sep. 24, 2010 (JP) 2010-214149

(51) Int. Cl. C09J 7/02

(52) U.S. Cl. 428/41.8

(57) ABSTRACT

With conventional protective sheets for displays, a space corresponding to the size of a hand is formed between the protective sheet and the display face, and thus it takes more time to bring the exposed face and the display into close contact, which increases the probability of dust contamination. There is also a problem that if the protective sheet were made from a highly rigid material, a space into which a hand could fit would not be produced.

In order to solve the above problems, in the present invention, a sheet affixing structure is provided, which is characterized in that a release sheet that is provided on an adhesive face of a protective sheet main body comprises two separate sheets, these being a first sheet and a second sheet, wherein the second sheet has a folded structure and one part of the folded free portion protrudes beyond the protective sheet.

### CROSS-REFERENCE TO RELATED APPLICATIONS

This application claims benefit of Japanese Patent application No. 2010-214149 filed on Sep. 24, 2010, the contents of which are hereby incorporated by reference.

### TECHNICAL FIELD

The present invention relates to a structure for facilitating the affixing of a sheet to the surface of a display, in order to protect the surface of the display or the like.

### TECHNICAL BACKGROUND

In recent years there have been advances in the miniaturization of display devices, and various portable digital gadgets having displays have been introduced, such as cell phones, smart phones, notebook computers and portable video players. When such digital gadgets are carried, they may make contact with various objects, and the display face is often damaged. Furthermore, touch operation, in which operations are performed by directly touching the display face, has recently become popular, and with touch operated digital gadgets, the display face may be soiled by the oil on hands, or scratched by contact with a stylus.

Thus, protective sheets that can be affixed to the display face have been provided in order to protect the display faces of such digital gadgets. These protective sheets have a silicone adhesive face, whereby they can be repeatedly affixed to, and removed from, the display face.

When a protective sheet is affixed to a display, if a speck of dust gets between the sheet and the display, an air bubble will form around the speck of dust, which presents problems in so much as this is unattractive, and the visibility of the display may be reduced. For this reason, protective sheets have been devised wherein a release sheet is provided on the adhesive face of the protective sheet, and the adhesive face is covered by the release sheet until immediately prior to application, so that dust does not adhere to the adhesive face.

However, if some time is taken between removing the release sheet and affixing the protective sheet to the display face, during this time, dust in the air will be attracted by way of static electricity or the like, so that the adhesive surface of the protective sheet will nonetheless be contaminated by dust. Thus, protective sheets have been provided wherein, for example, the release sheet has a structure which is divided into two or three parts, so that the protective sheet can be affixed to the display face, while incrementally removing the release sheet.

Alternatively, Patent Document 1 discloses a protective sheet, wherein one end of the release sheet that is provided on the adhesive face of the protective sheet can be separated and folded. With this protective sheet, the adhesive face that has been exposed by way of separating and folding one end of the release sheet is first affixed to the object to be protected, whereafter the folded portion serves as a handle, which is pulled so as to progressively separate the release sheet and expose the remaining adhesive face, which is affixed to the object to be protected.

### PRIOR ART DOCUMENTS

### Patent Documents

Patent Document 1: JP-2001-192628-A

### SUMMARY OF THE INVENTION

However, the conventional protective sheets described above have the following problems. With reference to the structure described in Patent Document 1, because the folded portion that serves as a handle is short, it is necessary for a hand to be inserted between the protective sheet and the display face to grip the handle. Consequently, a space corresponding to the size of the hand is formed between the protective sheet and the display face, and thus there is a problem in so much as it takes that much more time to bring the exposed face and the display into close contact, which increases the probability of dust contamination.

There is also a problem in so much as, if the protective sheet were made from a highly rigid material with a view to improving the protective function thereof (because, as a matter of course, the display itself cannot be bent), a space into which a hand could fit would not be produced.

In order to solve the problems described above, the present invention provides a sheet affixing structure comprising: a protective sheet main body, one face of which is used as an adhesive face for adhesion to a display face; and a release sheet that protects the adhesive face prior to adhesion of the protective sheet main body to the display face, wherein the release sheet comprises: a first sheet that is disposed in an initial area, which is an area of the adhesive face that is to be first affixed to an end area of the display; and a second sheet, which is separate from the first sheet, and is disposed in a main area, which is an area of the adhesive face that is to be affixed to a remaining area of the display, which is continuous on the end area of the display, comprising a contact portion that is folded in the vicinity of a border with the first sheet and makes close contact with the adhesive face, and a free portion that can overlay this contact portion and is of a size such that, in the overlaid state, one part thereof protrudes beyond the protective sheet main body.

Alternatively, instead of using a part of the adhesive face of the protective sheet main body as an initial area that is first affixed, a temporary fixing piece may be used in order to temporarily fix one end of the protective sheet main body in place. Specifically, a sheet affixing structure is provided, which comprises: a protective sheet main body, one face of which is used as an adhesive face for adhesion to a display face; a temporary fixing piece for temporarily fixing in place one end of the protective sheet main body, so that a place exterior to the display face serves as an anchor for the operations of affixing the protective sheet main body to the display face; and a release sheet, which protects the adhesive face prior to adhesion of the protective sheet main body to the display face, comprising a contact portion that and is folded in the vicinity of the one end of the protective sheet main body and makes close contact with the adhesive face, and a free portion that can overlay this contact portion and is of a size such that, in the overlaid state, one part thereof protrudes beyond the protective sheet main body.

Furthermore, a sheet affixing structure having the constitution described above is provided, wherein the protective sheet main body comprises a resin material. Furthermore, a sheet affixing structure having the constitution described above is provided, wherein the protective sheet main body comprises a material having high flexural rigidity.

By virtue of the present invention, which is constituted as described above, after fixing the positional relationship between the protective sheet and the display face, with the initial area or the temporary fixing piece as an anchor, it is possible to grip the free portion that protrudes to the exterior of the protective sheet main body, so that there is no need to produce a space for inserting a hand between the protective sheet main body and the display face. Next, while separating the release sheet by pulling the free portion that has been gripped in this manner, the adhesive face is progressively affixed to the display face, whereby the time for which the adhesive face is exposed is reduced, so that the protective sheet main body can be affixed to the display with a minimal amount of dust contamination.

Furthermore, because it is not necessary to provide a space into which a hand can fit, the protective sheet can comprise a highly rigid material. Accordingly, the capacity of the protective sheet to protect the display can also be improved.

### BRIEF DESCRIPTION OF THE DRAWINGS

FIGS. 1a-1b show perspective views illustrating one example of operations for affixing a protective sheet to a display, with a sheet affixing structure of a preferred embodiment;

FIG. 2a is a perspective view illustrating one example of operations for affixing the protective sheet to the display, with the sheet affixing structure of the preferred embodiment;

FIG. 2b is a side perspective view illustrating one example of operations for affixing the protective sheet to the display, with the sheet affixing structure of the preferred embodiment;

FIG. 2c is a perspective view illustrating one example of operations for affixing the protective sheet to the display, with the sheet affixing structure of the preferred embodiment;

FIG. 3a is a perspective view illustrating one example of a basic constitution of the sheet affixing structure of the preferred embodiment;

FIG. 3b is a side perspective view illustrating one example of the basic constitution of the sheet affixing structure of the preferred embodiment;

FIGS. 4a-4b show front views illustrating one example of an initial area of the sheet affixing structure of the preferred embodiment;

FIG. 5a is a perspective view illustrating one example of a second sheet in an unfolded state in the sheet affixing structure of the preferred embodiment;

FIG. 5b is a perspective view illustrating one example of a second sheet in a folded state in the sheet affixing structure of the preferred embodiment;

FIGS. 6a-6d show perspective views illustrating one example of operations for affixing a protective sheet to a display, with a sheet affixing structure of another embodiment; and

FIG. 7 is a perspective view illustrating one example of a basic constitution of the sheet affixing structure of another embodiment.

### MODES OF EMBODIMENT OF THE INVENTION

Hereafter, modes of embodiment of the present invention are described with reference to the drawings. Note that the present invention is in no way limited to these modes of embodiment, and can be embodied in various different modes without departing from the gist of the invention.

Note that the preferred embodiment primarily relates to claims 1, 3 and 4. Furthermore, another embodiment primarily relates to claims 2, 3 and 4.

### PREFERRED EMBODIMENT

### Summary

The sheet affixing structure of the present embodiment is characterized in that a release sheet, which is provided on an adhesive face of a protective sheet main body, comprises two separate sheets, these being a first sheet and a second sheet, wherein the second sheet has a folded structure and one part of a folded free portion protrudes beyond the protective sheet.

### Affixing Method

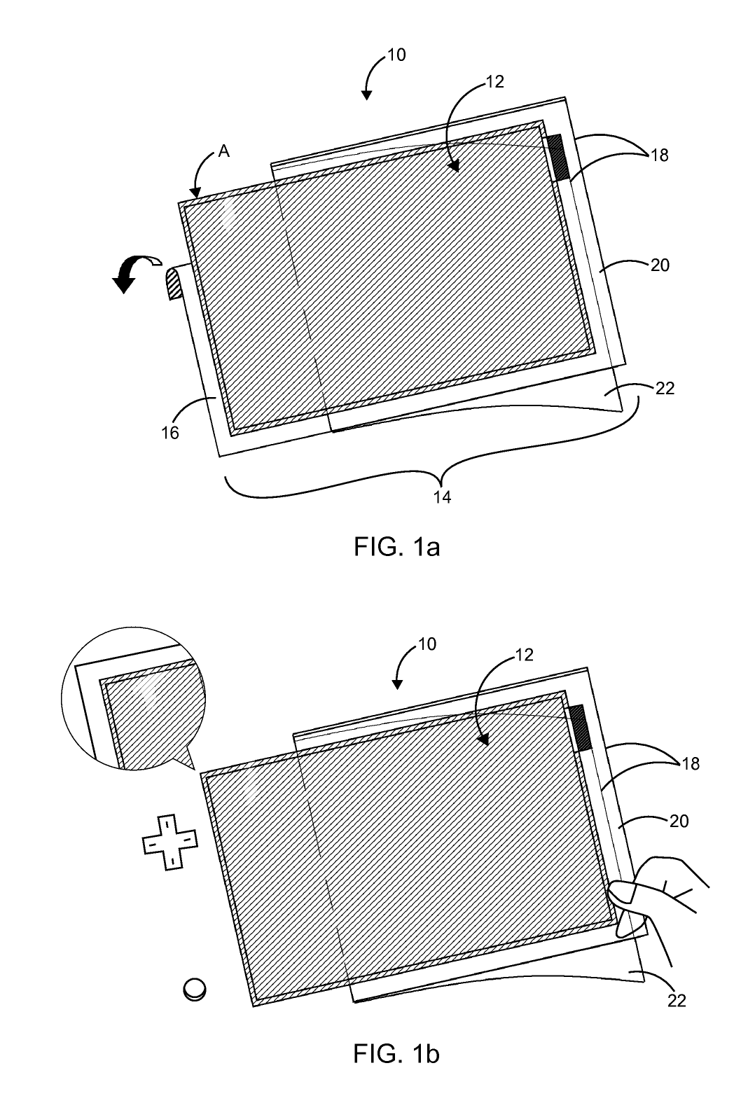

FIGS. 1a-1b show perspective views illustrating one example of operations for affixing a protective sheet main body 12 to a display face (not shown) with a sheet affixing structure 10 of a preferred embodiment. The sheet affixing structure 10 comprises the protective sheet main body 12 having two faces in which one face is used as an adhesive face prior to adhesion to the display face (not shown). A release sheet 14 configured to protect the adhesive face (not shown) prior to adhesion of the protective sheet main body 12 to the display face (not shown) comprises a first sheet 16 and a second sheet 18. The first sheet 16 disposed in an initial area A of the adhesive face (not shown) is affixed to an end area of the display face (not shown). The second sheet 18, which is separate from the first sheet 16, and disposed in a main area of the adhesive face (not shown) is to be affixed to a remaining area of the display face (not shown), which is continuous on the end area of the display face (not shown). The second sheet 18 includes a contact portion 20 and a free portion 22. The contact portion 20 is folded in the vicinity of a border with the first sheet 16 and makes close contact with the adhesive face (not shown). The free portion 22 can overlay the contact portion 20 and is of a size such that, in the overlaid state, the free portion 22 protrudes beyond the protective sheet main body 12. In the preferred embodiment, the sheet affixing structure 10 is placed in such a way that the protective sheet main body 12 is viewed upwards and the adhesive face (not shown) downwards.

For fixing the sheet affixing structure on a display, first soiling and dust are removed from the display face with a clean cloth or the like. Then, as shown in FIG. 1a, the first sheet 16 is removed in the anticlockwise direction indicated by the arrow, so as to expose an initial area A of the adhesive face. Then after placing the protective sheet main body 12 lightly on the display face (not shown), so as to position it, the initial area A that has been exposed is slowly affixed to the display face (not shown) of the digital gadget (not shown), as shown in FIG. 1b. A user can pull out the protruded free portion of the second sheet 22 in order to affix the remaining part of the protective sheet main body 12 to the display face (not shown).

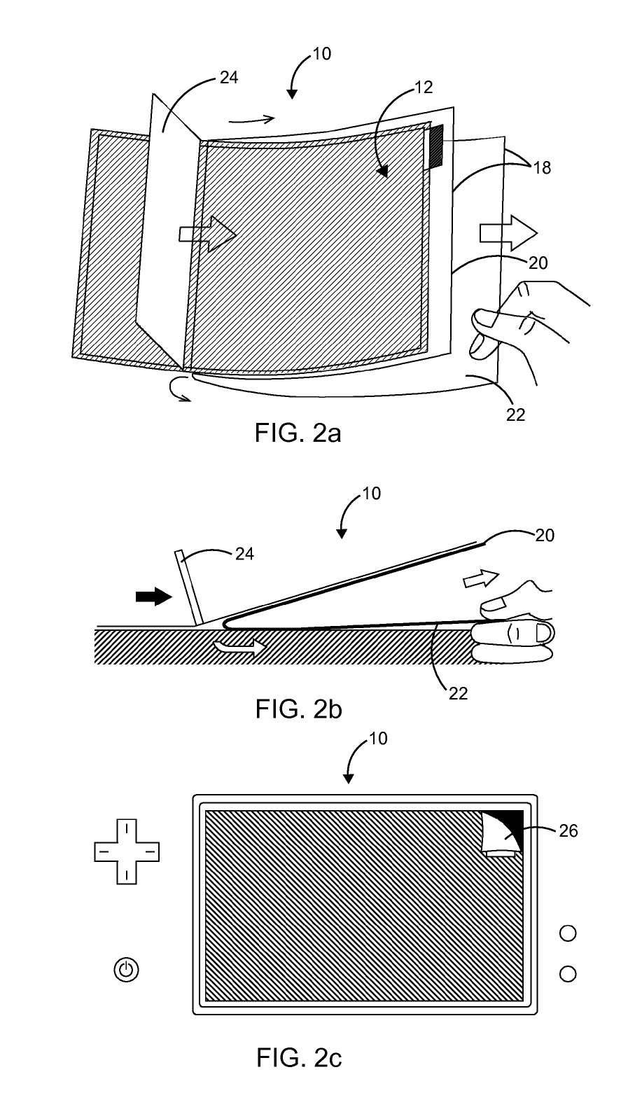

With reference to FIG. 2a, for example, while pressing down on the protective sheet main body 12 with a spatula 24 or the like, the free portion 22, which protrudes from the right side of the protective sheet main body 12, is gripped by a hand, and the main area of the adhesive face (not shown) is progressively exposed as this is pulled to the right. Furthermore, in conjunction with the operation of pulling the free portion 22, the position at which the spatula 24 is pressed is moved to the right so that, the protective sheet main body 12 is progressively affixed to the display face (not shown), from the exposed portion of the main area. FIG. 2b is a side perspective view of the sheet affixing structure 10 in which the affixing process described above is viewed from the side.

Moreover, after the entire protective sheet main body 12 has been affixed to the display face (not shown), a protective sheet surface protection film 26, which has been provided on the surface of the protective sheet main body 12, is removed so as to complete the application as shown in FIG. 2c.

### Basic Constitution

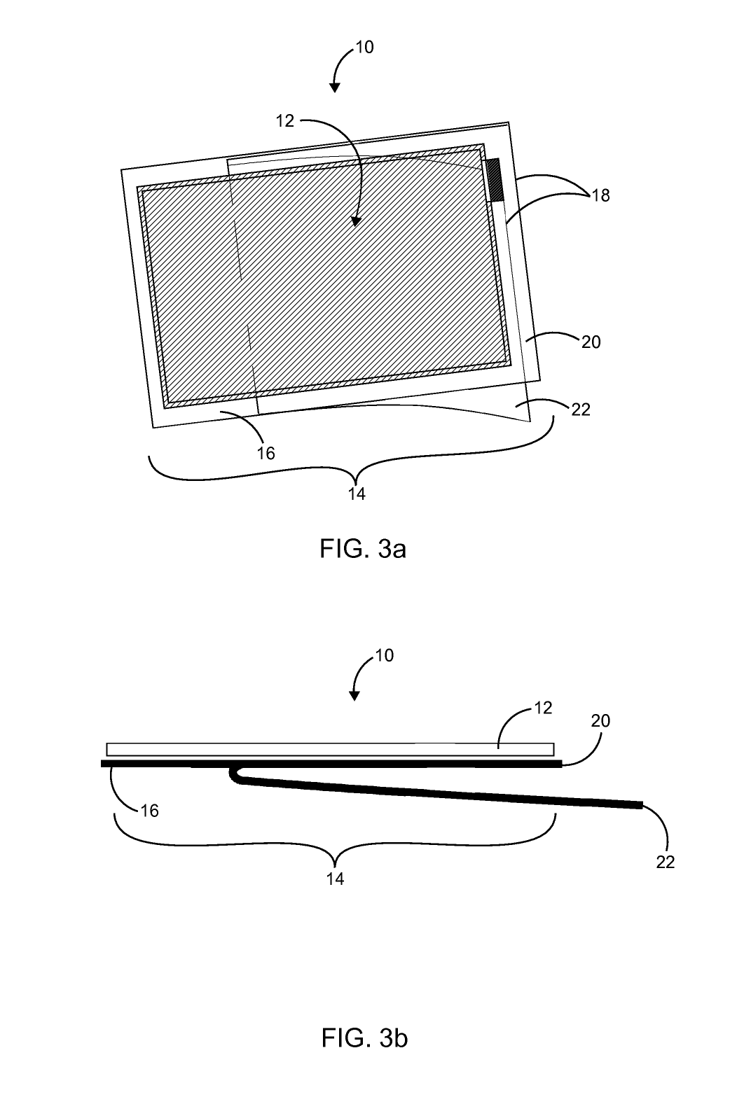

FIG. 3a is a perspective view illustrating one example of a basic constitution of the sheet affixing structure 10 of the preferred embodiment and FIG. 3b is a side perspective view.

The protective sheet main body 12 is a sheet-form structure, one side of which is used as an adhesive face (not shown) for adhesion to a display face (not shown), and possible materials for the same include, for example, hard coated PET (polyethylene terephthalate), polyester film coated with an elastomer resin, other resin materials, high rigidity acrylics and the like.

Furthermore, there are no particular restrictions on the method for endowing one side of the protective sheet main body 12 with an adhesive face function, but methods such as laminating an adhesive silicone layer to the bottommost layer of the protective sheet main body 12, or applying a solvent for adhesion purposes, which does not reduce visibility, are possible.

Note that, in addition to the protective sheet main body 12 that is intended for protection, for example, glare/non-glare sheets, anti-peeping sheets and the like, will also ultimately play this protective role if affixed to the display screen. Accordingly, in the present embodiment, the term protective sheet main body 12 includes sheet-form structures that can be affixed to a display face (not shown) and provides such functions other than a protection function. Furthermore, in this case, materials may be provided, and processing may be performed, for the purpose of endowing the protective sheet main body 12 with such functions other than a protection function.

Furthermore, the display face (not shown) to which the protective sheet main body 12 is affixed by way of the adhesive face (not shown) may be a display screen that displays video and the like alone, but this may also include other structures such as, for example, a “bezel”, which is a protective frame around a display screen.

The release sheet 14 has the function of protecting the adhesive face (not shown) prior to adhesion of the protective sheet main body 12 to the display face (not shown). Specifically, by affixing the release sheet 14 to the adhesive face (not shown), the adhesive face (not shown) is protected prior to the protective sheet main body 12 being affixed to the display face (not shown), at times such as, for example, during transport, or during display in a store.

Moreover, so long as this is in sheet-form, there are no particular restrictions on the materials for the release sheet 14, but as this serves to temporarily cover the adhesive face (not shown) of the protective sheet main body 12, it is preferable that the materials and shape be such as to facilitate release from the adhesive face (not shown), or that these have undergone processing that facilitates release.

Next, the protective sheet main body 12 is affixed to the display (not shown), which is performed by separating the release sheet 14 from the adhesive face (not shown) and bringing the exposed adhesive face (not shown) into close contact with the display (not shown). However, the longer the time, the adhesive face (not shown) is exposed without being brought into close contact with the display (not shown), the greater the possibility of dust getting between the protective sheet main body 12 and the display (not shown), resulting in the formation of air bubbles.

Thus, in order to minimize the period of time during which the adhesive face (not shown) is exposed, the release sheet 14 of the preferred embodiment is characterized by comprising a first sheet 16 and a second sheet 18 having structures such as described below.

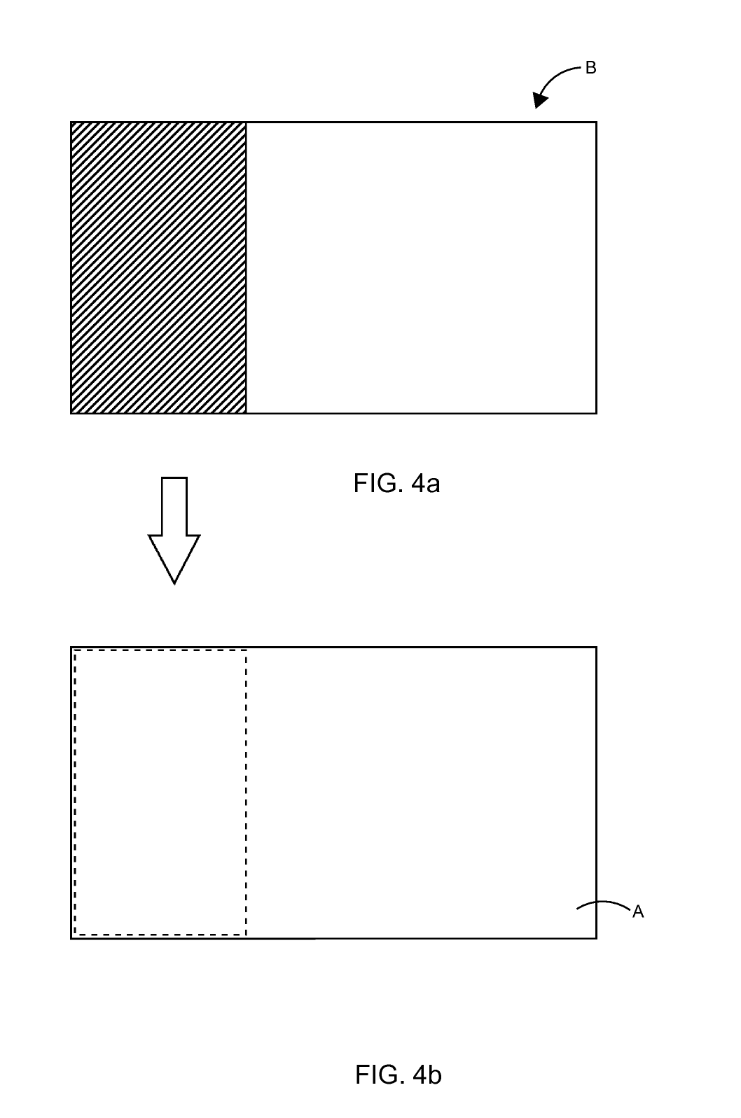

The first sheet 16 refers to a sheet that constitutes a part of the release sheet 14, which is disposed in the initial area A of the adhesive face (not shown). The initial area A refers to an area of the adhesive face (not shown) that is to be first affixed to the end area of the display and, for example, as shown in FIGS. 4a-4b, this may be an area of, for example, one third of the adhesive face (not shown) of the protective sheet main body B, in the crosswise direction, indicated by the diagonal hatching, which corresponds to the right end area of the display A, as indicated by the dashed line.

Note that there are no particular restrictions on the shape of the initial area A but this preferably has a shape conforming to the shape of the display, suitable for affixing at an end thereof. Furthermore, the first sheet 16, which is disposed in the initial area A, may be configured so as to allow this to be further divided into two or more sheets, or the like.

Furthermore, as described in the foregoing summary, this initial area of the adhesive face (not shown) is affixed to the end area of the display face (not shown) in the ordinary way after the first sheet 16 has been removed. Consequently, it can easily be contaminated by dust, and thus it is desirable that the area of the initial area be as small as possible. In this regard, the area may, for example, be approximately equal to the end area that constitutes, for example, one tenth of the display in the lengthwise or crosswise direction (the direction in which a free portion of the second sheet 22, described hereafter is pulled), so that the initial affixing will ensure a force sufficient to hold the protective sheet main body 12 in position. Furthermore, an area equal to the end area that constitutes one half or more in the same lengthwise or crosswise direction would be excessively large, as the area could easily be contaminated by dust, as described above, which is undesirable.

Next, this initial area of the adhesive face is affixed to the display face (not shown), and serves as an anchor for the operations of affixing the protective sheet main body 12 to the display face (not shown).

The second sheet 18 is separate from the first sheet 16, and is disposed in the main area of the adhesive face. The main area refers to an area of the adhesive face (not shown) that is to be affixed to the remaining portion of the display face (not shown), which is continuous on the aforementioned end area of the display face (not shown) and, as with the initial area, there are no particular restrictions on the shape thereof. The planar dimensions thereof do not pose any particular problem, because the constitution that is described hereafter allows the main area be affixed to the display face (not shown) with an extremely short exposure time.

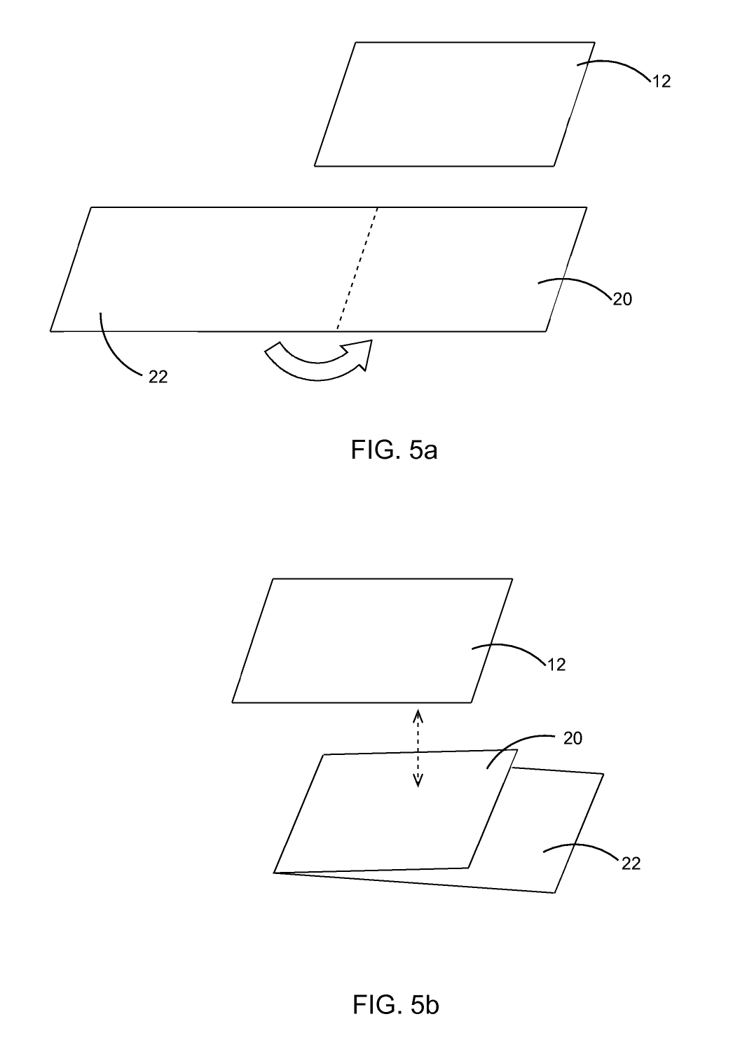

FIG. 5a is a perspective view illustrating one example of the second sheet 18 in an unfolded state and FIG. 5b is a perspective view illustrating one example of the second sheet 18 in a folded state. The second sheet 18 is characterized by the folded structure, comprising the contact portion 20 and the free portion 22, with a fold line that is indicated by the dashed line as a boundary there between. The second sheet 18 has been folded at the fold line and the contact portion 20 and the free portion 22 have been overlaid.

The free portion 22 is capable of being overlaid with the contact portion 20 by way of the aforementioned folding and is characterized by being of a size such that, in the overlaid state, the free portion 22 protrudes beyond the protective sheet main body 12. Specifically, the free portion 22, which has been folded in the vicinity of the boundary with the first sheet 16, protrudes beyond the protective sheet main body 12 in its folded state, for example, as shown in FIG. 5b. Consequently, the free portion 22 can easily be grasped and pulled, even with the protective sheet main body 12 and the display face (not shown) in close contact.

Note that there are no particular restrictions on the degree to which the free portion 22 protrudes, the shape thereof or the like, but it is preferable that the degree to which this protrudes and the shape thereof allow it to fulfill the function of being grasped by the hand and pulled. Grasping and pulling is easy if, for example, the degree to which this protrudes is 5 mm to 1 cm or more. Furthermore, as differs from the contact portion 20, there is no need for this to fully cover the adhesive face (not shown), and therefore the shape can be freely chosen with consideration for ease of grasp, ease of processing, and resistance to tearing when pulled.

Furthermore, because the second sheet 18 is folded into a contact portion 20 and a free portion 22 in this manner, it is preferable that the material be easy to fold, and because a part of the second sheet 18 will always be in contact with the display face (not shown) while being pulled away, it is preferable that the material be such that the portion making contact will not damage the screen.

Note that the sheet affixing structure 10 of the present invention is a structure that is suitable for affixing, not only to the aforementioned portable digital gadget displays (not shown), but also to displays such as those of stationary televisions and desktop computers.

### BRIEF DESCRIPTION OF THE EFFECTS

By virtue of the sheet affixing structure 10 of the present embodiment having a constitution such as described above, by grasping and pulling the free portion 22 that protrudes to the exterior of the protective sheet main body 12, the adhesive face (not shown) can be progressively affixed to the display face (not shown) while removing the release sheet 14. Accordingly, the time for which the adhesive face (not shown) is exposed can be shortened, so that the protective sheet main body 12 can be affixed to the display face (not shown) with a minimal amount of dust contamination.

Furthermore, because the protective sheet main body 12 can be affixed to the display face (not shown) as is, without altering the shape thereof by way of flexing or the like, a highly rigid material can be used for the protective sheet main body 12. Accordingly, the capacity of the protective sheet 12 to protect the display face (not shown) can also be improved.

### ANOTHER EMBODIMENT

### Summary

The sheet affixing structure of another embodiment 50 is similar to that of the preferred embodiment 10 described above, in that the release sheet 14 has a folded structure and one part of the folded free portion 22 protrudes beyond the protective sheet main body 12. A feature of another embodiment 50 is that the portion that is first affixed in order to serve as an anchor for the affixing operations is not a part of the adhesive face 24 (initial area) as in the preferred embodiment 10 described above, but rather this is a temporary fixing piece 52 that can easily be removed after the affixing operations are complete.

In other words, because the initial area is affixed to the display face (not shown) in the ordinary way after peeling off the first sheet 16, in the same manner as in conventional methods, there is a problem in so much as contamination by dust and the like can readily occur in this area, in the same manner as was conventional. However, in another embodiment 50, a temporary fixing piece 52 is separately provided, which can easily be removed after the affixing operations, whereby the entire protective sheet main body 54 can be affixed in a such a way that contamination by dust on the like does not readily occur.

### Affixing Method

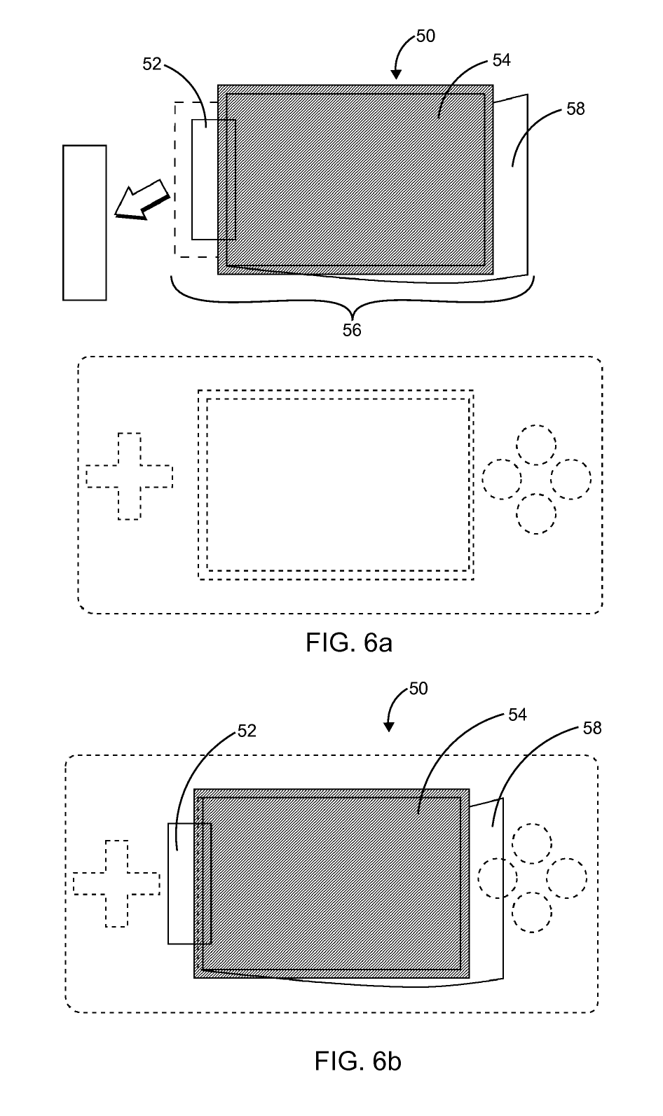

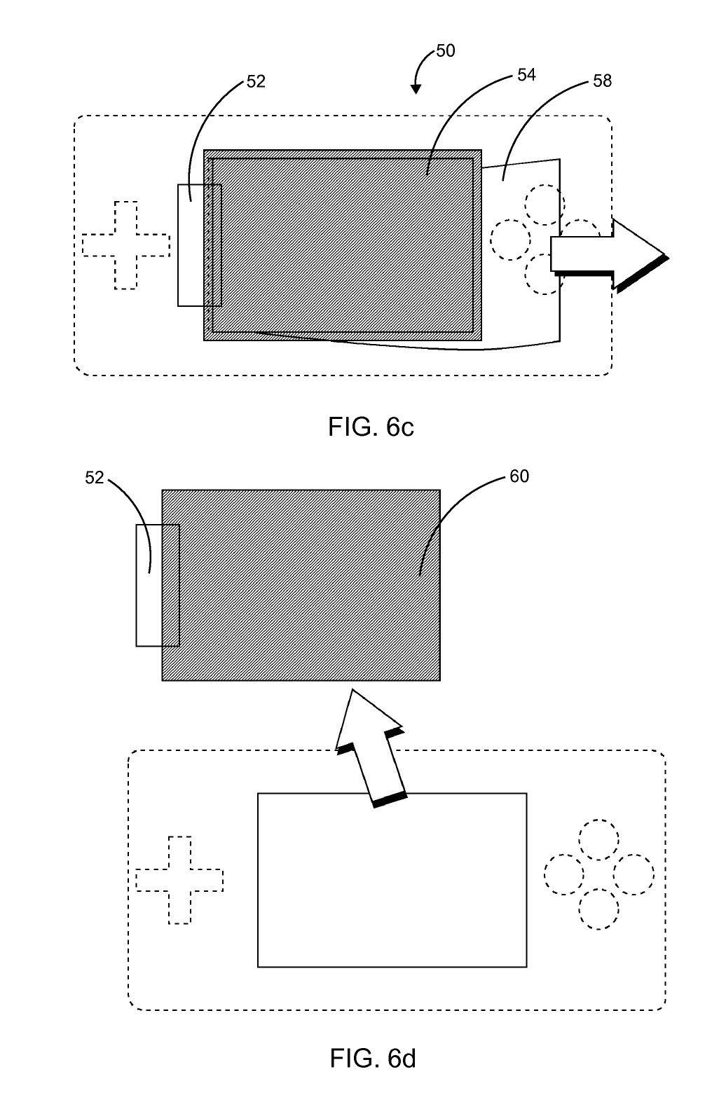

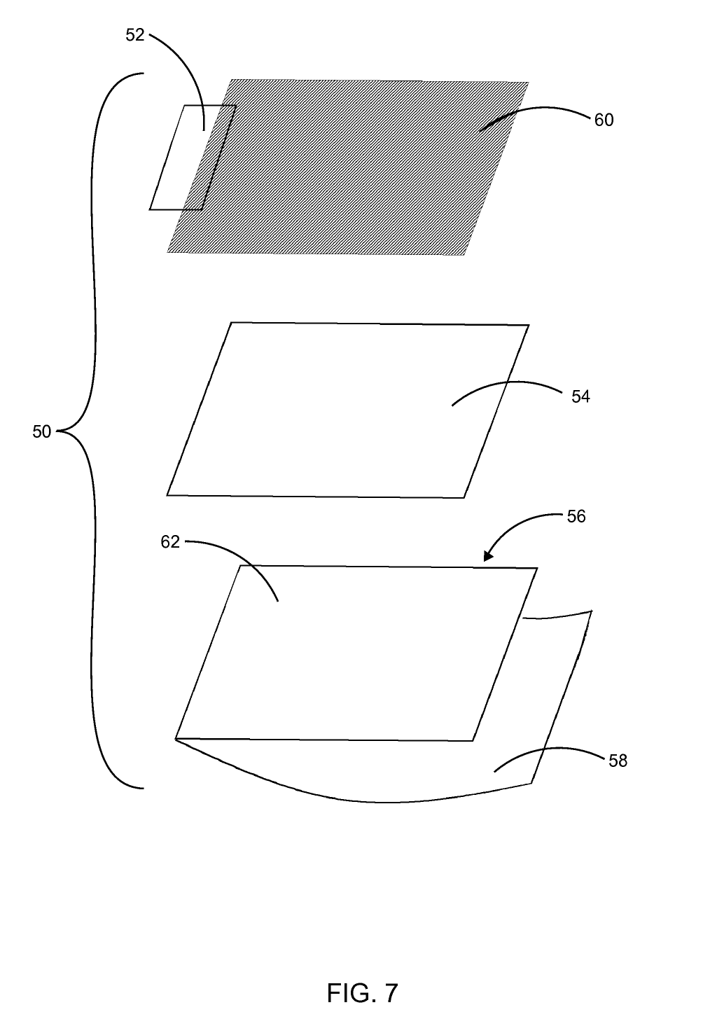

FIGS. 6a-6d show perspective views illustrating one example of operations for affixing the protective sheet main body 54 to a display, with the sheet affixing structure 50 of an another embodiment. First, as shown in FIG. 6a, a release sheet 56 for the temporary fixing piece 52, which has been provided on the adhesive face of the temporary fixing piece (not shown), is removed. Then, as shown in FIG. 6b, the protective sheet main body 54 is positioned to match the display face (not shown) of the display, to which the protective sheet main body 54 is to be affixed, which is indicated by the dashed line, and when the position is correct, the temporary fixing piece 52 is affixed to, and thereby fixed in place on, an outer frame or the like of the display screen.

Subsequently, for example, while pressing down on the protective sheet main body 54 with a spatula or the like, in the same manner as the preferred embodiment described above, while the free portion 58 is gripped by a hand and pulled in the direction of the arrow, as shown in FIG. 6c, the progressively exposed adhesive face is affixed. Next, when the entire protective sheet main body 54 has been affixed to the display face (not shown), the temporary fixing piece 52 is removed, as shown in FIG. 6d, (if there is a protection film on the top face of the protective sheet main body 54, the temporary fixing piece 52 is removed together therewith) so as to complete the affixing of the protective sheet main body 54 to the display face (not shown).

### Basic Constitution

FIG. 7 is a perspective view in which the protective sheet main body 54 is on top, and the components have been separated with their positional relationships maintained.

The protective sheet main body 54 is a sheet-form structure, one face of which is used as an adhesive face for adhesion to a display face (not shown). Note that this protective sheet main body 54 is similar to that described above in the preferred embodiment 10, and thus a detailed description is omitted.

The temporary fixing piece 52 refers to a structure that serves to temporarily fix one end of the protective sheet main body 54 in place, so that a place exterior to the display face (not shown) serves as an anchor for the operations of affixing the protective sheet main body 54 to the display face (not shown). Furthermore, temporarily fix in place so that a place exterior to the display face (not shown) serves as an anchor means initially affixing this temporary fixing piece 52 at a place exterior to the display face (not shown), so that the two are temporarily fixed in place (which is to say, in a manner whereby the temporary fixing piece 52 can subsequently be removed) so as to serve as an anchor for performing the various operations necessary for affixing, such as aligning the sheet affixing structure 50 of the present embodiment and the display face (not shown). That is to say, by way of this temporary fixing piece 52, the two can be fixed in place without affixing the protective sheet main body 54 to the display face (not shown).

In cases where the display face (not shown) is a display screen alone, the “place exterior to the display face” at which this is temporarily fixed in place may be the bezel or the like. Furthermore, in cases where the display face also includes the bezel or another display screen frame, this may be affixed onto a side of the object of the affixing process, or the like.

The temporary fixing piece 52 is configured so that one part protrudes to the exterior of the protective sheet main body 54, and the portion that protrudes has an adhesive function, whereby it can be affixed so that it serves as an anchor at a place exterior to the display face (not shown).

There are no particular restrictions on the material for the temporary fixing piece 52 but examples include PET, polyester film, acrylic and the like. So long as this is configured so that one part thereof protrudes to the exterior of the protective sheet main body 54, there are likewise no particular restrictions on the size or the shape thereof. This may be a strip, which is smaller than the protective sheet main body 54, as shown in FIG. 6c, or may be of a size such as to cover the entire upper face (the opposite side from the adhesive face) of the protective sheet main body 54, and shaped so that one end thereof protrudes to the exterior of the protective sheet main body 54, so as to allow for temporarily fixing in place.

Furthermore, there are no particular restrictions on the configurational position of the temporary fixing piece 52 within the sheet affixing structure of another embodiment 50, so long as this is a position that allows for easy removal after the operations of affixing the protective sheet main body 54 have been performed. For example, (provided that the size of the temporary fixing piece is that of a small strip) this may be provided between the adhesive face of the protective sheet main body 54 and the release sheet 56, in the vicinity of the edge on the side of the fold in the release sheet 56, but, in general, it is preferable that this be provided on the top side of the protective sheet main body 54.

Furthermore, there are no particular restrictions on the adhesive mechanism for temporary fixing in place of the temporary fixing piece 52, and such methods can be used as laminating an adhesive silicone layer or the like onto the bottommost layer of the temporary fixing piece 52, or applying a solvent for the purpose of adhesion to the adhesive face of the temporary fixing piece 52. Furthermore, during transport or during display in a store, prior to fixing in place, an adhesive mechanism protection member (separator) may preferably be provided on the adhesive mechanism of the portion that protrudes beyond the protective sheet main body 54 for temporary fixing in place.

Furthermore, so as to prevent abrasion of the surface and the like, during transport, sales display or the like, a protection film 60 may be provided on the top face of the protective sheet main body as shown in FIG. 7. In this case, if the temporary fixing piece 52 is provided on this protection film 60, when the protection film 60 is removed, the temporary fixing piece 52 can also be removed together therewith. Alternatively, as described above, the constitution may be such that the temporary fixing piece 52 is of a size that covers the entire protective sheet main body 54, and shaped so that one end thereof protrudes to the exterior of the protective sheet main body 54, so as to allow for temporary fixing in place, whereby the temporary fixing piece 52 fulfills the function of the aforementioned protection film 60.

The release sheet 56, has the function of protecting the adhesive face prior to adhesion of the protective sheet main body 54 on the display (not shown). Note that this function, as well as the structure thereof and the like, have been described above in the preferred embodiment, and thus a detailed description is omitted.

The difference with respect to the preferred embodiment 10 is that the release sheet 14 does not have structure wherein this is divided into a first sheet 14 and a second sheet 18. This is because, as described above, in another embodiment, the sheet affixing structure 50 is characterized by having a temporary fixing piece 52 instead of an initial area A, the first sheet 14 being disposed in the initial area.

In other words, in another embodiment, the release sheet 56, is constituted by a structure similar to the second sheet 18 in the preferred embodiment 10 alone. Specifically, this release sheet 56, functions so as to protect the adhesive face, and is characterized by comprising a contact portion 62 that is folded in the vicinity of the one end of the protective sheet main body 54 and makes close contact with the adhesive face, and a free portion 58 that can overlay this contact portion 62 and is of a size such that, in the overlaid state, one part thereof protrudes beyond the other end of the protective sheet main body 54.

Note that description of the contact portion 62 and the free portion 58, and detailed description of affixing the protective sheet main body 54 by pulling the free portion 58 and the like are omitted, as these have already been described above in the preferred embodiment.

### BRIEF DESCRIPTION OF THE EFFECT

By virtue of the sheet affixing structure of the present embodiment having a constitution such as described above, the adhesive face can be progressively affixed to the display face while removing the release sheet, by grasping and pulling the free portion that protrudes to the exterior of the protective sheet main body. Accordingly, the time for which the adhesive face is exposed can be shortened, so that the protective sheet main body can be affixed to the display with a minimal amount of dust contamination.

Furthermore, by way of temporarily fixing this in place with the temporary fixing piece, it is possible to shorten the time for which the adhesive face of the entire protective sheet is exposed.

### EXPLANATION OF THE REFERENCE NUMERALS

10 sheet affixing structure
12 protective sheet main body
14 release sheet
16 first sheet
18 second sheet
20 contact portion
22 free portion
24 spatula
26 protection film

1. A sheet affixing structure comprising:
a protective sheet main body, one face of which is used as an adhesive face for adhesion to a display face; and
a release sheet that protects the adhesive face prior to adhesion of the protective sheet main body to the display face;
wherein the release sheet comprises:
a first sheet that is disposed in an initial area, which is an area of the adhesive face that is to be first affixed to an end area of the display; and
a second sheet, which is separate from the first sheet, and is disposed in a main area, which is an area of the adhesive face that is to be affixed to a remaining area of the display, which is continuous on the end area of the display, the second sheet comprising a contact portion that is folded in the vicinity of a border with the first sheet and makes close contact with the adhesive face, and a free portion that can overlay this contact portion and is of a size such that, in the overlaid state, one part thereof protrudes beyond the protective sheet main body.

2. A sheet affixing structure comprising:
a protective sheet main body, one face of which is used as an adhesive face for adhesion to a display face;
a temporary fixing piece for temporarily fixing in place one end of the protective sheet main body, so that a place exterior to the display face serves as an anchor for operations of affixing the protective sheet main body to the display face; and
a release sheet, which protects the adhesive face prior to adhesion of the protective sheet main body to the display face, comprising a contact portion that is folded in the vicinity of the one end of the protective sheet main body and makes close contact with the adhesive face, and a free portion that can overlay this contact portion and is of a size such that, in the overlaid state, one part thereof protrudes beyond the other end of the protective sheet main body.

3. The sheet affixing structure recited in claim 1 or 2, wherein the protective sheet main body comprises a resin material.

4. The sheet affixing structure recited in any one of claims 1 to 3, wherein the protective sheet main body comprises a material having high flexural rigidity.
